(19) United States
(12) Patent Application Publication
(10) Pub. No.: US 2017/0322670 A1
(43) Pub. Date: Nov. 9, 2017

(54) METAL MESH STRUCTURE CAPABLE OF REDUCING BREAKPOINT SHORT CIRCUIT AND METHOD OF MANUFACTURING THE SAME

(71) Applicants: Interface Optoelectronics (ShenZhen) Co., Ltd., Shenzhen (CN); General Interface Solution Limited, Miaoli County (TW)

(72) Inventors: Wan-Chun Wang, Miaoli County (TW); Jhe-Wei Zeng, Miaoli County (TW); Yue-Feng Yang, Miaoli County (TW); Po-Lin Chen, Miaoli County (TW); Yen-Heng Huang, Miaoli County (TW)

(21) Appl. No.: 15/201,876

(22) Filed: Jul. 5, 2016

(30) Foreign Application Priority Data
May 5, 2016 (CN) 201610293730.4

(51) Int. Cl. G06F 3/041

(52) U.S. Cl. CPC G06F 3/0418; G06F 2203/04103; G06F 2203/04112

(57) ABSTRACT

A metal mesh structure capable of reducing breakpoint short circuits, including a plurality of first main channel wires, a plurality of second main channel wires, a plurality of first virtual wires and a plurality of second virtual wires. The first main channel wires are spaced apart and aligned in a first direction. The second main channel wires are spaced apart and aligned in a second direction. The second main channel wires cross the first main channel wires to form a plurality of main channel meshes. A method of manufacturing a metal mesh structure capable of reducing breakpoint short circuits is further provided. Given the aforesaid structure and method, the metal mesh is effective in reducing breakpoint short circuits.

### CROSS-REFERENCE TO RELATED APPLICATION

This application claims priority of application No. 201610293730.4, filed on May 5, 2016 in the State Intellectual Property Office of the People's Republic of China.

### BACKGROUND OF THE INVENTION

### Field of the Invention

The present invention relates to metal mesh structures capable of reducing breakpoint short circuits and methods of manufacturing the same and, more particularly, to a metal mesh structure capable of reducing breakpoint short circuits by increasing break points and a method of manufacturing the same.

### Description of the Prior Art

A metal mesh, which is made of an electrically conductive material, looks like a mesh composed of extremely thin wires mounted on a touch sensor. It is intended to substitute for conventional electrically conductive materials, such as indium tin oxide (ITO) film. Conversely, ITO cannot replace metal meshes. Furthermore, ITO has its own application limitation, that is, the electrical conductivity of ITO film is too low to meet needs beyond those for medium-sized and large-sized touch panels. By contrast, metal mesh-based touch technology is free of any size-related limitation in terms of product application and thereby has higher competitiveness.

Metal meshes provide high expectations for next-generation important touch technology, mainly because of their low impedance, low incurred expenses, slightly lower manufacturing costs than ITO, better transparency than ITO, and high flexibility. Therefore, metal mesh touch panels are applicable to large-sized electronic devices, such as notebook computers and personal computers.

Metal mesh touch panels operate at resistance of less than 0.1 Ohm and therefore are applicable to large-sized, medium-sized and small-sized electronic devices, especially notebook computers and personal computers with medium-sized or large-sized touch panels, because the low surface resistance characteristic of metal meshes is conducive to reduction in the quantity of required integrated circuits, thereby further enhancing the price competitiveness of metal mesh touch panel modules.

Referring to FIG. 1, according to the prior art, a metal mesh structure (7) capable of reducing breakpoint short circuits comprises a plurality of first main channel wires (70), a plurality of second main channel wires (71), a plurality of first virtual wires (72) and a plurality of second virtual wires (73).

The first main channel wires (70) are spaced apart and aligned in a first direction (8). The second main channel wires (71) are spaced apart and aligned in a second direction (9). The second main channel wires (71) cross the first main channel wires (70) to form a plurality of main channel meshes (74).

The first virtual wires (72) are spaced apart and aligned in the first direction (8). One end of each of a portion of the first virtual wires (72) is connected to one end of a corresponding one of the first main channel wires (70).

The second virtual wires (73) are spaced apart and aligned in the second direction (9). One end of each of a portion of the second virtual wires (73) is connected to one end of a corresponding one of the second main channel wires (71). The second virtual wires (73) cross the first main channel wires (70) and the first virtual wires (72) to form a plurality of virtual meshes (75).

The virtual meshes (75) each comprise four sides. The sides are formed of the first main channel wires (70), the second main channel wires (71), the first virtual wires (72) or the second virtual wires (73). Each of the sides of the first virtual wires (72) or the second virtual wires (73) which the virtual meshes (75) are formed of comprises at least one break point (750).

However, according to the prior art, if manufacturing process abnormality happens, the metal mesh structure (7) capable of reducing breakpoint short circuits will create short circuits at break points and produce parasitic capacitance indicated by the dashed line of FIG. 1, thereby leading to a test anomaly.

Therefore, it is important for related equipment manufacturers and researchers to devise a metal mesh structure capable of reducing breakpoint short circuits in case of manufacturing process abnormality and a method of manufacturing the same.

### SUMMARY OF THE INVENTION

In view of the aforesaid drawbacks of the prior art, i.e., a metal mesh is likely to create short circuits at break points because of manufacturing process abnormality, the inventor of the present invention carried out research, conducted tests, made efforts repeatedly, and eventually developed the present invention.

The first objective of the present invention is to provide a metal mesh structure capable of reducing breakpoint short circuits.

In order to achieve the above and other objectives, the present invention provides a metal mesh structure capable of reducing breakpoint short circuits, comprising a plurality of first main channel wires, a plurality of second main channel wires, a plurality of first virtual wires and a plurality of second virtual wires.

The first main channel wires are spaced apart and aligned in a first direction. The second main channel wires are spaced apart and aligned in a second direction. The second main channel wires cross the first main channel wires to form a plurality of main channel meshes.

The first virtual wires are spaced apart and aligned in the first direction. One end of each of a portion of the first virtual wires is connected to one end of a corresponding one of the first main channel wires.

The second virtual wires are spaced apart and aligned in the second direction. One end of each of a portion of the second virtual wires is connected to one end of a corresponding one of the second main channel wires. The second virtual wires cross the first main channel wires and the first virtual wires to form a plurality of virtual meshes.

The virtual meshes each comprise four sides. The sides are formed of the first main channel wires, the second main channel wires, the first virtual wires or the second virtual wires. The virtual meshes are formed of the first virtual wires or the second virtual wires. At least one of the sides of the first virtual wires or the second virtual wires which the virtual meshes are formed of comprises at least two break points. The break points divide the first virtual wires or the second virtual wires into multiple segments.

The second objective of the present invention is to provide a method of manufacturing a metal mesh capable of reducing breakpoint short circuits.

In order to achieve the above and other objectives, the present invention provides a method of manufacturing a metal mesh capable of reducing breakpoint short circuits, comprising:
step A: providing a plurality of first main channel wires spaced apart and aligned in a first direction;
step B: providing a plurality of second main channel wires spaced apart and aligned in a second direction, wherein the second main channel wires cross the first main channel wires to form a plurality of main channel meshes;
step C: providing a plurality of first virtual wires spaced apart and aligned in the first direction, wherein one end of each of a portion of the first virtual wires is connected to one end of a corresponding one of the first main channel wires; and
step D: providing a plurality of second virtual wires spaced apart and aligned in the second direction, wherein one end of each of a portion of the second virtual wires is connected to one end of a corresponding one of the second main channel wires, wherein the second virtual wires cross the first main channel wires and the first virtual wires to form a plurality of virtual meshes.

The virtual meshes each comprise four sides. The sides are formed of the first main channel wires, the second main channel wires, the first virtual wires or the second virtual wires. The virtual meshes are formed of the first virtual wires or the second virtual wires. At least one of the sides of the first virtual wires or the second virtual wires which the virtual meshes are formed of comprises at least two break points. The break points divide the first virtual wires or the second virtual wires into multiple segments.

Given the aforesaid structure and method, the present invention prevents a metal mesh structure thereof from developing a short circuit by providing at least one additional break point on the sides of virtual meshes so that another break point will still be available even if manufacturing process abnormality causes a breakpoint short circuit to the metal mesh structure.

### BRIEF DESCRIPTION OF THE DRAWINGS

FIG. 1 (PRIOR ART) is a structural schematic view of a conventional metal mesh structure;

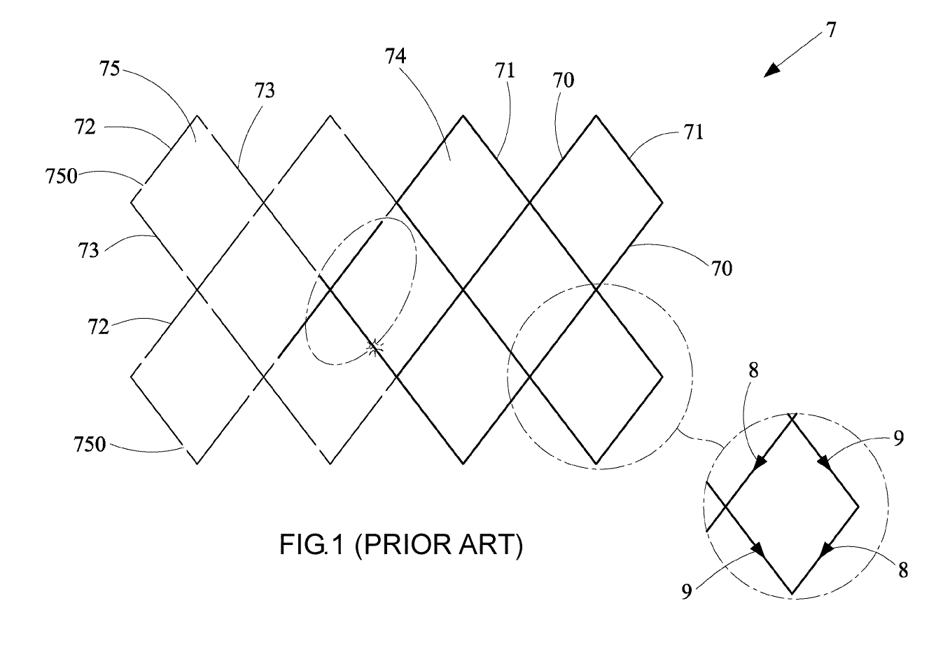

FIG. 2a is a structural schematic view of a metal mesh structure capable of reducing breakpoint short circuits according to an embodiment of the present invention;

FIG. 2b is a structural schematic view of a metal mesh structure capable of reducing breakpoint short circuits according to another embodiment of the present invention; and

FIG. 3 is a flow chart of the process flow of a method of manufacturing a metal mesh capable of reducing breakpoint short circuits according to the present invention.

### DETAILED DESCRIPTION OF THE EMBODIMENTS

To enable persons skilled in the art to gain insight into the objectives of the present invention, preferred embodiments of the present invention are illustrated with drawings and described below.

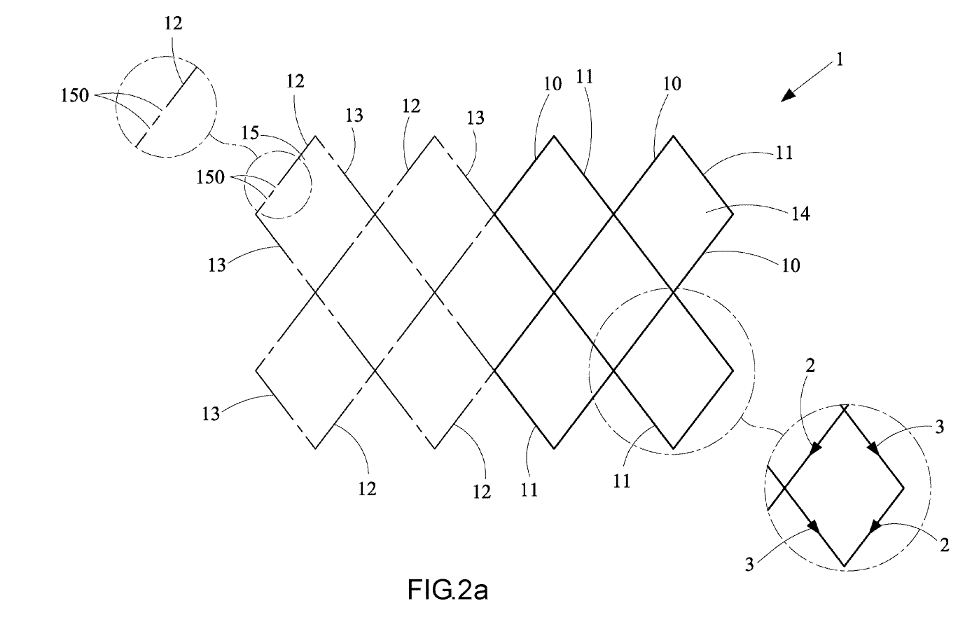

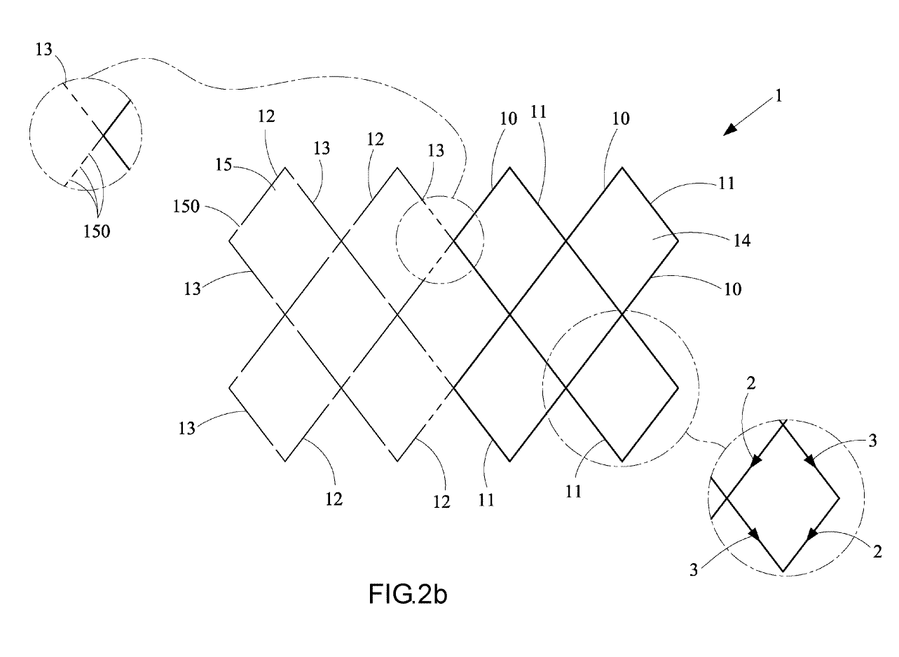

Referring to FIG. 2a, according to the present invention, a metal mesh structure (1) capable of reducing breakpoint short circuits comprises a plurality of first main channel wires (10), a plurality of second main channel wires (11), a plurality of first virtual wires (12) and a plurality of second virtual wires (13)

The first main channel wires (10) are spaced apart and aligned in a first direction (2). The second main channel wires (11) are spaced apart and aligned in a second direction (3). The second main channel wires (11) cross the first main channel wires (10) to form a plurality of main channel meshes (14).

The first virtual wires (12) are spaced apart and aligned in the first direction (2). One end of each of a portion of the first virtual wires (12) is connected to one end of a corresponding one of the first main channel wires (10).

The second virtual wires (13) are spaced apart and aligned in the second direction (3). One end of each of a portion of the second virtual wires (13) is connected to one end of a corresponding one of the second main channel wires (11). The second virtual wires (13) cross the first main channel wires (10) and the first virtual wires (12) to form a plurality of virtual meshes (15).

The virtual meshes (15) each comprise four sides. The sides are formed of the first main channel wires (10), the second main channel wires (11), the first virtual wires (12) or the second virtual wires (13). The virtual meshes (15) are formed of the first virtual wires (12) or the second virtual wires (13). At least one of the sides of the first virtual wires (12) or the second virtual wires (13) which the virtual meshes (15) are formed of comprises at least two break points (150). The break points (150) divide the first virtual wires (12) or the second virtual wires (13) into multiple segments.

Referring to FIG. 2b, in another preferred embodiment of the present invention, one side of one of the virtual meshes (15) comprises a break point (150), and the other side of the virtual mesh (15) comprises three break points (150).

In a preferred embodiment of the present invention, the first direction (2) and the second direction (3) are perpendicular to each other.

In another preferred embodiment of the present invention, the first main channel wires (10), the second main channel wires (11), the first virtual wires (12) and the second virtual wires (13) are made of silver, copper, gold, aluminum, tungsten, brass, iron, tin or platinum.

In yet another preferred embodiment of the present invention, the break points (150) are of a length of 1.5 μm to 15 μm.

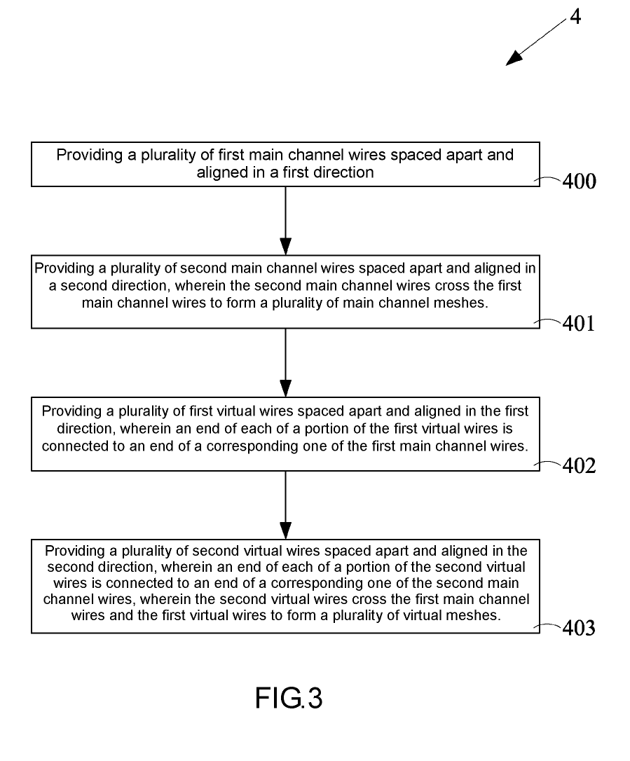

Referring to FIG. 2 and FIG. 3, according to the present invention, a method (4) of manufacturing a metal mesh capable of reducing breakpoint short circuits comprises the steps as follows:
Step 400: providing a plurality of first main channel wires (10) spaced apart and aligned in a first direction (2);
Step 401: providing a plurality of second main channel wires (11) spaced apart and aligned in a second direction (3), wherein the second main channel wires (11) cross the first main channel wires (10) to form a plurality of main channel meshes (14);
Step 402: providing a plurality of first virtual wires (12) spaced apart and aligned in the first direction (2), wherein an end of each of a portion of the first virtual wires (12) is connected to an end of a corresponding one of the first main channel wires (10); and
Step 403: providing a plurality of second virtual wires (13) spaced apart and aligned in the second direction (3), wherein an end of each of a portion of the second virtual wires (13) is connected to an end of a corresponding one of the second main channel wires (11), wherein the second virtual wires (13) cross the first main channel wires (10) and the first virtual wires (12) to form a plurality of virtual meshes (15).

The virtual meshes (15) each comprise four sides. The sides are formed of the first main channel wires (10), the second main channel wires (11), the first virtual wires (12) or the second virtual wires (13). The virtual meshes (15) are formed of the first virtual wires (12) or the second virtual wires (13). At least one of the sides of the first virtual wires (12) or the second virtual wires (13) which the virtual meshes (15) are formed of comprises at least two break points (150). The break points (150) divide the first virtual wires (12) or the second virtual wires (13) into multiple segments.

In a preferred embodiment of the present invention, the first direction (2) and the second direction (3) are perpendicular to each other.

In another preferred embodiment of the present invention, the first main channel wires (10), the second main channel wires (11), the first virtual wires (12) and the second virtual wires (13) are made of silver, copper, gold, aluminum, tungsten, brass, iron, tin or platinum.

In yet another preferred embodiment of the present invention, the break points (150) are of a length of 1.5 μm to 15 μm.

Given the aforesaid structure and method, the present invention prevents a metal mesh structure thereof from developing a short circuit by providing at least one additional break point on the sides of virtual meshes so that another break point will still be available even if manufacturing process abnormality causes a breakpoint short circuit to the metal mesh structure. Furthermore, the structural features of the metal mesh structure of the present invention cannot be readily conceived and accomplished by persons skilled in the art and therefore has novelty and non-obviousness.

The above description fully shows that the objectives and advantages of the present invention are non-obvious and have high industrial applicability, and that the present invention is commercially novel, thereby meeting the requirements of an invention patent. The present invention is disclosed above by preferred embodiments, but the preferred embodiments should not be interpreted as restrictive of the scope of the present invention. Hence, all equivalent changes and modifications made to the aforesaid embodiments should fall within the scope of the claims of the present invention.

What is claimed is:

1. A metal mesh structure capable of reducing breakpoint short circuits, comprising:
a plurality of first main channel wires spaced apart and aligned in a first direction;
a plurality of second main channel wires spaced apart and aligned in a second direction, wherein the second main channel wires cross the first main channel wires to form a plurality of main channel meshes;
a plurality of first virtual wires spaced apart and aligned in the first direction, wherein an end of each of a portion of the first virtual wires is connected to an end of a corresponding one of the first main channel wires; and
a plurality of second virtual wires spaced apart and aligned in the second direction, wherein an end of each of a portion of the second virtual wires is connected to an end of a corresponding one of the second main channel wires, wherein the second virtual wires cross the first main channel wires and the first virtual wires to form a plurality of virtual meshes,
wherein the virtual meshes each comprise four sides formed of the first main channel wires, the second main channel wires, the first virtual wires or the second virtual wires, wherein at least one of the sides of the first virtual wires or the second virtual wires which the virtual meshes are formed of comprises at least two break points, wherein the break points divide the first virtual wires or the second virtual wires into multiple segments.

2. The metal mesh structure capable of reducing breakpoint short circuits according to claim 1, wherein the first direction and the second direction are perpendicular to each other.

3. The metal mesh structure capable of reducing breakpoint short circuits according to claim 1, wherein the first main channel wires, the second main channel wires, the first virtual wires and the second virtual wires are made of one of silver, copper, gold, aluminum, tungsten, brass, iron, tin, and platinum.

4. The metal mesh structure capable of reducing breakpoint short circuits according to claim 2, wherein the first main channel wires, the second main channel wires, the first virtual wires and the second virtual wires are made of one of silver, copper, gold, aluminum, tungsten, brass, iron, tin, and platinum.

5. The metal mesh structure capable of reducing breakpoint short circuits according to claim 1, wherein the break points are of a length of 1.5 μm to 15 μm.

6. The metal mesh structure capable of reducing breakpoint short circuits according to claim 2, wherein the break points are of a length of 1.5 μm to 15 μm.

7. The metal mesh structure capable of reducing breakpoint short circuits according to claim 3, wherein the break points are of a length of 1.5 μm to 15 μm.

8. The metal mesh structure capable of reducing breakpoint short circuits according to claim 4, wherein the break points are of a length of 1.5 μm to 15 μm.

9. A method of manufacturing a metal mesh capable of reducing breakpoint short circuits, comprising:
step A: providing a plurality of first main channel wires spaced apart and aligned in a first direction;
step B: providing a plurality of second main channel wires spaced apart and aligned in a second direction, wherein the second main channel wires cross the first main channel wires to form a plurality of main channel meshes;
step C: providing a plurality of first virtual wires spaced apart and aligned in the first direction, wherein an end of each of a portion of the first virtual wires is connected to an end of a corresponding one of the first main channel wires; and
step D: providing a plurality of second virtual wires spaced apart and aligned in the second direction, wherein an end of each of a portion of the second virtual wires is connected to an end of a corresponding one of the second main channel wires, wherein the second virtual wires cross the first main channel wires and the first virtual wires to form a plurality of virtual meshes,
wherein the virtual meshes each include four sides formed of the first main channel wires, the second main channel wires, the first virtual wires or the second virtual wires, wherein the virtual meshes are formed of the first virtual wires or the second virtual wires, wherein at least one of the sides of the first virtual wires or the second virtual wires which the virtual meshes are formed of includes at least two break points which divide the first virtual wires or the second virtual wires into multiple segments.

10. The method of manufacturing a metal mesh capable of reducing breakpoint short circuits according to claim 9, wherein the first direction and the second direction are perpendicular to each other.

11. The method of manufacturing a metal mesh capable of reducing breakpoint short circuits according to claim 9, wherein the first main channel wires, the second main channel wires, the first virtual wires and the second virtual wires are made of one of silver, copper, gold, aluminum, tungsten, brass, iron, tin, and platinum.

12. The method of manufacturing a metal mesh capable of reducing breakpoint short circuits according to claim 10, wherein the first main channel wires, the second main channel wires, the first virtual wires and the second virtual wires are made of one of silver, copper, gold, aluminum, tungsten, brass, iron, tin, and platinum.

13. The method of manufacturing a metal mesh capable of reducing breakpoint short circuits according to claim 9, wherein the break points are of a length of 1.5 μm to 15 μm.

14. The method of manufacturing a metal mesh capable of reducing breakpoint short circuits according to claim 10, wherein the break points are of a length of 1.5 μm to 15 μm.

15. The method of manufacturing a metal mesh capable of reducing breakpoint short circuits according to claim 11, wherein the break points are of a length of 1.5 μm to 15 μm.

16. The method of manufacturing a metal mesh capable of reducing breakpoint short circuits according to claim 12, wherein the break points are of a length of 1.5 μm to 15 μm.
